(19) United States
(12) Patent Application Publication
(10) Pub. No.: US 2008/0036325 A1
(43) Pub. Date: Feb. 14, 2008

(54) Stator of a magneto generator

(75) Inventors: Mitsuharu Hashiba, Tokyo (JP); Akifumi Miyake, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/706,187

(22) Filed: Feb. 15, 2007

(30) Foreign Application Priority Data
Aug. 10, 2006 (JP) 2006-218309

(51) Int. Cl. H02K 21/22

(52) U.S. Cl. 310/153

(57) ABSTRACT

A stator of a magneto generator serves to make parts control easy and reduce the production cost. The stator includes a plurality of teeth each having a straight portion extending in a radially outer direction and a flange portion protruding in a circumferential direction from a tip end of the straight portion, and a magneto coil having a conductor wound around each of the teeth. The stator core includes a laminated iron core composed of a plurality of intermediate plates laminated one over another, and end plates arranged in intimate contact with opposite side surfaces of the laminated iron core. The intermediate plates and the end plates are formed of the same plate materials each having a flange segment. The end plates have a bent portion formed by bending the flange segment and serves to prevent the magneto coils from collapsing in the radially outer direction.

### BACKGROUND OF THE INVENTION

1. Field of the Invention

The present invention relates to a stator of a magneto generator having a generator coil that generates electricity under the action of an alternating field from a permanent magnet in accordance with the rotation of a flywheel.

2. Description of the Related Art

As a stator of a conventional magneto generator, there has been known one which includes a stator core that is arranged at an inner side of a plurality of permanent magnets fixedly secured to an inner peripheral wall surface of a bowl-shaped flywheel, and has a plurality of teeth each comprising a straight portion that extends in a diametrally outer direction and a flange portion that protrudes in a circumferential direction from a tip end of the straight portion, and a magneto coil that has a conductor wound around each of the teeth for generating electric power by means of an alternating field from the permanent magnets, wherein the stator core includes a laminated core composed of a plurality of intermediate plates laminated one over another, and a pair of end plates that are arranged at the opposite side surfaces of the laminated core so as to clamp it from the opposite sides thereof.

In addition, each of the end plates is provided with an L-shaped bent portion having a tip end at an outer peripheral side upstanding and bent in a direction toward a diametrally inner side, so as to prevent the magneto coil from collapsing in a radially outer direction at this bent portion (see, for example, a first patent document: Japanese patent application laid-open No. 2004-135382 (FIG. 1)).

However, in the stator of the magneto generator as constructed above, each of the end plates is larger in thicknesses and diametral size than each of the intermediate plates, so there arise the following problems. That is, it is necessary to prepare different plate materials for the end plates and the intermediate plates, respectively, and hence parts control become troublesome and the production cost becomes high.

### SUMMARY OF THE INVENTION

Accordingly, the present invention is intended to obviate the problems as referred to above, and has for its object to obtain a stator of a magneto generator in which parts control becomes easy and the production cost can be reduced.

Bearing the above object in mind, a stator of a magneto generator according to the present invention includes: a stator core that is arranged at an inner side of a plurality of permanent magnets fixedly secured to an inner peripheral wall surface of a bowl-shaped flywheel, and has a plurality of teeth each having a straight portion that extends in a radially outer direction and a flange portion that protrudes in a circumferential direction from a tip end of the straight portion; and a magneto coil that has a conductor wound around each of the teeth for generating electric power by means of an alternating field from the permanent magnets. The stator core includes a laminated iron core composed of a plurality of intermediate plates laminated one over another, and end plates that are arranged in intimate contact with opposite side surfaces of the laminated iron core. The intermediate plates and the end plates are formed of the same plate materials each having a flange segment that is a component element of the flange portion. At least one of the end plates arranged on at least one of the side surfaces has a bent portion that is formed by bending the flange segment and serves to prevent the magneto coils from collapsing in the radially outer direction.

According to a stator of a magneto generator of the present invention, parts control becomes easy and at the same time the production cost can be reduced.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a front elevational view showing a stator of a magneto generator according to a first embodiment of the present invention.

FIG. 2 is a cross sectional side view of the stator of FIG. 1.

FIG. 3 is an enlarged view of essential portions of the stator of FIG. 1.

FIG. 4 is an enlarged view of essential portions of the stator of FIG. 4.

FIG. 5 is a front elevational view of a stator core of FIG. 2 with an insulating material being omitted.

FIG. 6 is front partial view of a stator of a magneto generator according to a second embodiment of the present invention.

FIG. 7 is a partial view when the stator of FIG. 6 is seen from the direction of arrow C.

FIG. 8 is a front partial view of a stator of a magneto generator according to a third embodiment of the present invention.

FIG. 9 is a partial view when the stator of FIG. 8 is seen from the direction of arrow D.

FIGS. 10A thru 10C are views illustrating a procedure of forming a bent portion of FIG. 8.

### DESCRIPTION OF THE PREFERRED EMBODIMENTS

Now, preferred embodiments of the present invention will be described in detail while referring to the accompanying drawings. Throughout respective figures, the same or corresponding members or parts are identified by the same reference numerals and characters.

### Embodiment 1

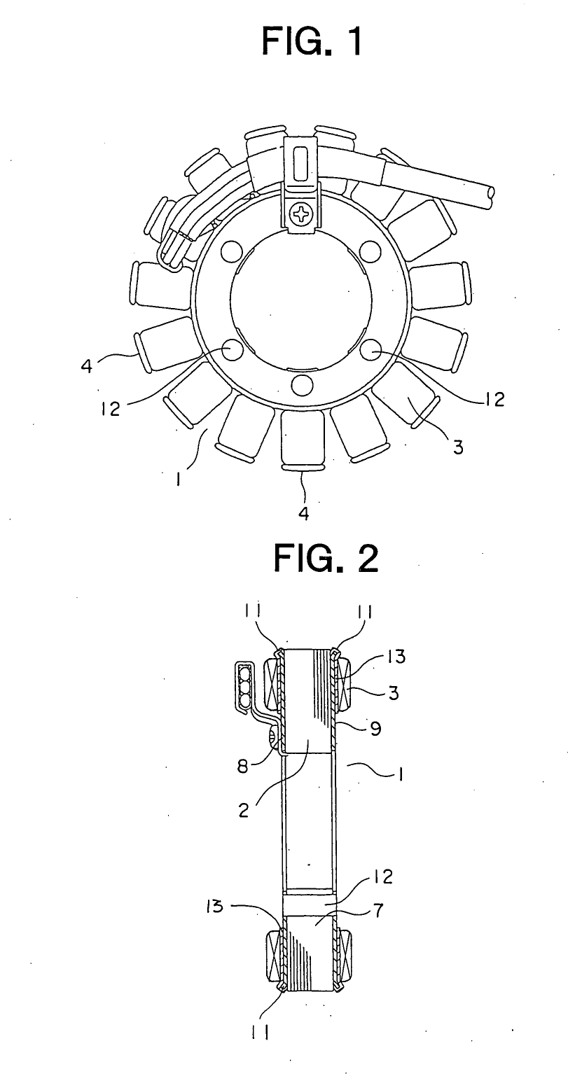

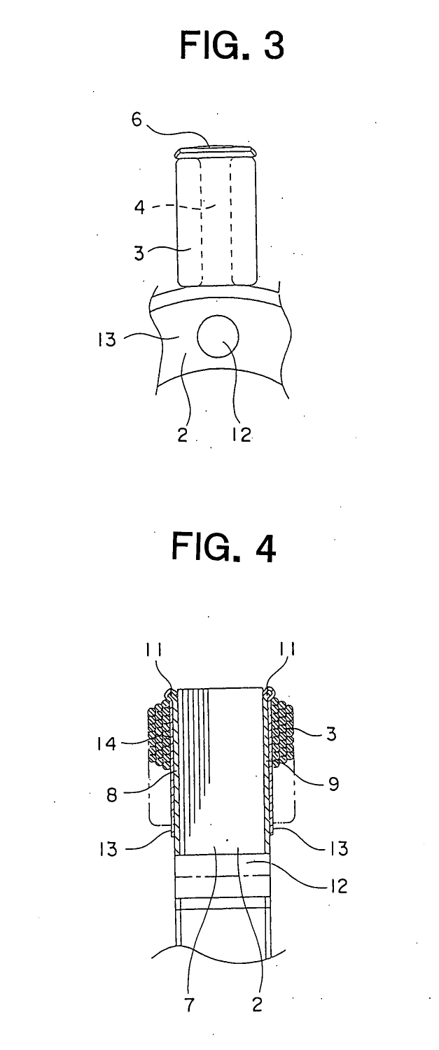

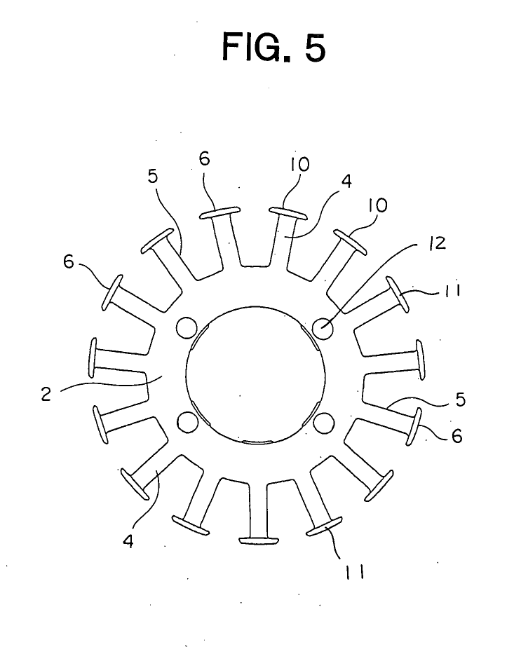

Referring to the drawings and first to FIG. 1, there is shown a stator 1 of a magneto generator according to a first embodiment of the present invention. FIG. 2 is a cross sectional side view thereof, and FIG. 3 is an enlarged view of essential portions of the stator 1 of FIG. 1. FIG. 4 is an enlarged view of the essential portions of the stator 1 of FIG. 2, and FIG. 5 is a front elevational view of a stator core 2 of FIG. 1 (with an insulating material 13 being omitted).

This magneto generator is provided with a rotor (not shown) operatively connected with an internal combustion engine and a stator 1 disposed at an inner side of the rotor.

The rotor has a plurality of permanent magnets (not shown) fixedly attached to an inner peripheral wall surface of a bowl-shaped flywheel (not shown). The flywheel is fixedly secured to a rotation shaft (not shown) which is driven to rotate by the internal combustion engine.

The stator 1 mounted on an unillustrated fixing member has a hollow cylindrical stator core 2 and magneto coils 3. The stator core 2 is formed on its outer periphery with a plurality of radially outwardly extending teeth 4 arranged at equal intervals in a circumferential direction thereof.

A conductive wire 14 in the form of a copper wire is wound around the side surface of each tooth 4 through an insulating material 13 to form a corresponding magneto coil 3 mounted thereon. Each of the teeth 4 is composed of a straight portion 5 that extends to a radially outer side, and a flange portion 6 that protrudes in a circumferential direction from a tip end of the straight portion 5.

The stator core 4 having the plurality of teeth 13 formed on its outer peripheral portion is composed of a laminated iron core 7 which is formed of a multitude of thin magnetic steel plates in the form of hollow intermediate plates of cold rolled steel plates laminated one over another in a direction of the axis of rotation, and a first end plate 8 and a second end plate 9 arranged on the opposite side surfaces of the laminated iron core 7, respectively, in intimate contact therewith.

The intermediate plates, the first end plate 8 and the second end plate 9, which together constitute a part of the laminated iron core 7, are formed of plate materials having the same thickness, configuration and quality or property.

The first end plate 8 and the second end plate 9 have flange segments 10, respectively, which constitute the flange portion 6 and are bent so as to upstand toward the magneto coil 3, i.e., in a radially inner direction, to form bent portions 11, respectively.

A plurality of through holes 12, which penetrate the laminated iron core 7 and the first and second end plates 8, 9 in parallel to the axis of rotation thereof, are formed in the radially inner peripheral portions of the laminated iron core 7 and the first and second end plates 8, 9. The laminated iron core 7 and the first and second end plates 8, 9 arranged in intimate contact with the opposite side surfaces of the laminated core 7 are integrated with one another by bolts (not shown) penetrating through the through holes 12 and nuts (not shown) threaded over the end portions of the bolts.

In the magneto generator as constructed above, the unillustrated flywheel is rotated in association with the unillustrated rotation shaft which is driven to rotate by the internal combustion engine, whereby electric power is generated in the magneto coils 3 by the alternating fields which are brought about by the unillustrated permanent magnets at that time. An AC output thus generated is rectified by an unillustrated rectifier diode, and fed to loads such as a battery mounted on a vehicle.

According to the stator 1 of the magneto generator of this embodiment, the intermediate plates, the first end plate 8 and the second end plate 9 are formed of the same plate materials, so parts control becomes easy, and at the same time molds for molding the plate materials need only be of a single kind alone, thus making it possible to reduce the production cost.

In addition, the flange segments 10 of the first end plate 8 and the second end plate 9 are formed with the bent portions 11, respectively, which upstand in the radially inner direction, so the bent portions 11 serve to prevent the magneto coils 3 from collapsing in a radially outer direction.

Here, note that the bending height of each bent portion 11 may be about a half or more of the diameter of the conductor 14 in case where the winding form of the conductor 14 is formed in such a manner that the magneto coil 3 is of a so-called strawbag stacked form, as shown in FIG. 14.

Further, even if the flange segments 10 temporarily return to their original states prior to bending thereof due to a reduction in the rigidity of the bent portions 11, the outer diameters of the end plates 8, 9 are the same as the outer diameter of the intermediate plates, and hence the end plates 8, 9 do not become impediments to the rotation of the rotor.

### Embodiment 2

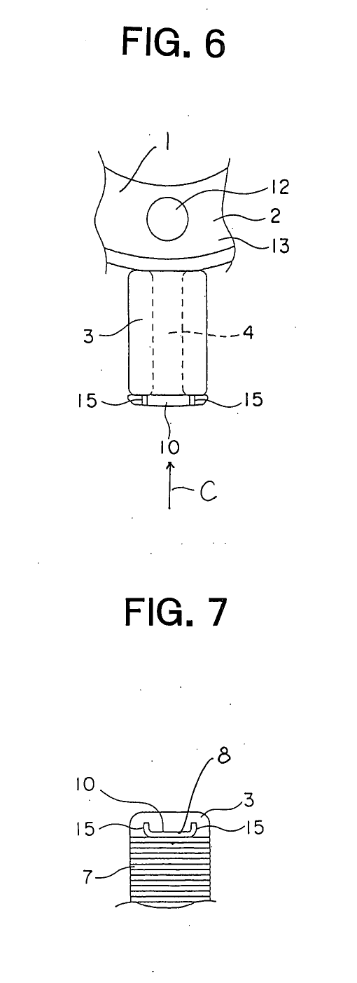

FIG. 6 is front partial view of a stator 1 of a magneto generator according to a second embodiment of the present invention, and FIG. 7 is a partial view when the stator 1 of FIG. 6 is seen from the direction of arrow C.

In this second embodiment, each of a first end plate 8 and a second end plate 9 has a pair of bent portions 15 which are formed by making opposite side portions of a flange segment 10 bent to upstand in a circumferential direction. The construction of this second embodiment other than the above is similar to that of the first embodiment.

According to the stator 1 of the magneto generator of this second embodiment, the bending height of the bent portions 15 is higher than that of the bent portions 11 of the first embodiment, so the magneto coils 3 are prevented from collapsing in a radially outer direction in a more reliable manner as compared with the first embodiment.

In addition, the rigidity in the radially outer direction of the bent portions 15, which are bent in a circumferential direction, is larger as compared with the rigidity in the radially outer direction of the bent portions 11 of the first embodiment which are bent in the radial direction. As a result, the reliability of the bent portions 15 with respect to a load from the magneto coils 3 is higher as compared with that of the bent portions 11 of the first embodiment.

### Embodiment 3

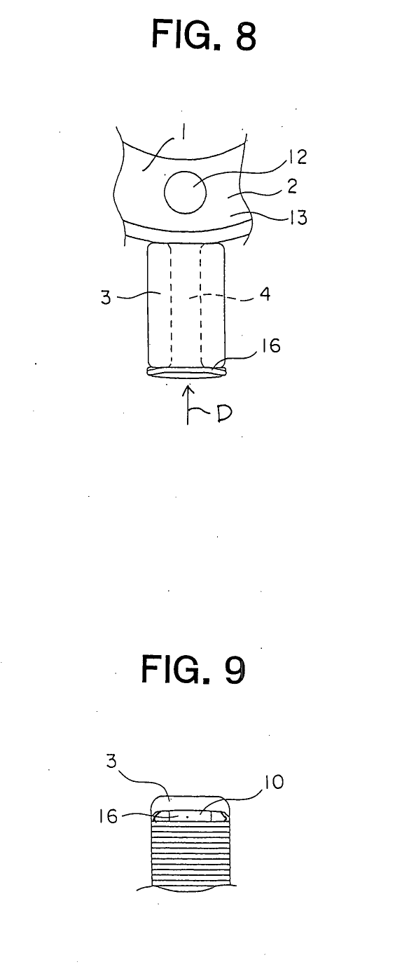

FIG. 8 is a front partial view of a stator 1 of a magneto generator according to a third embodiment of the present invention. FIG. 9 is a partial view when the stator 1 of FIG. 8 is seen from the direction of arrow D.

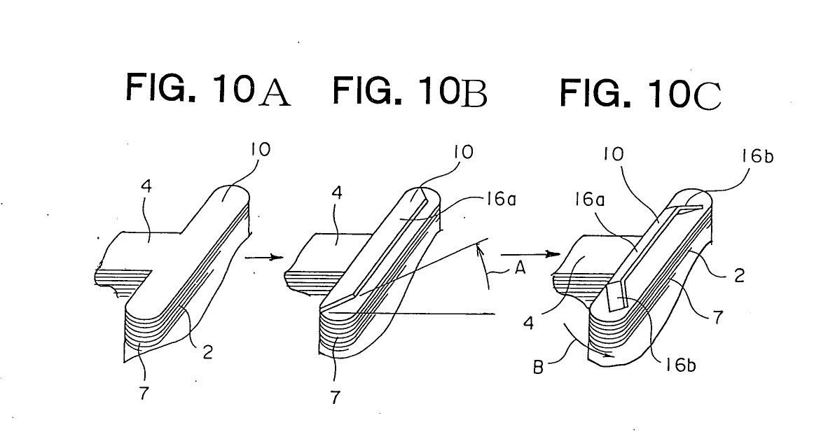

In this third embodiment, a bent portion 16 including a first bent segment 16a and a pair of second bent segments 16b is formed in the following manner. That is, a flange segment 10 (see FIG. 10A) is bent so as to upstand in a radially inner direction, as shown by an arrow A, to form the first bent segment 16a (FIG. 10B), and subsequently, the opposite sides of the flange segment 10 are bent so as to upstand in a circumferential direction, as shown in an arrow B, to form the second bent segment 16b (FIG. 10C). The construction of this third embodiment other than the above is similar to that of the first embodiment.

According to the stator 1 of the magneto generator of this third embodiment, the bent portion 16 has, in addition to the first bent segment 1 6a, the second bent segments 16b which are formed by bending the opposite sides of the first bent segment 16a so as to upstand in a circumferential direction. With this construction, the bent portion 16 is larger in the rigidity in a radially outer direction as compared with each bent portion 15 of the first embodiment, and hence the reliability of the bent portion 16 with respect to a load from the magneto coils 3 is higher as compared with that of each bent portion 11 of the first embodiment.

In the above-mentioned respective embodiments, reference has been made to the case where the bent portions 11, 15, 16 are formed on both of the end plates 8, 9, respectively, which are in intimate contact with the opposite sides of the laminated iron core 7, but a bent portion may be formed on only one of the end plates 8, 9 in case where a conductor is wound around each tooth 4 in an aligned manner with little or no fear that a collapse of the magneto coils 3 might occur.

In addition, in order to raise the rigidity of the end plates 8, 9, a plurality of pieces of end plates may be used in a superposed or stacked manner.

While the invention has been described in terms of preferred embodiments, those skilled in the art will recognize that the invention can be practiced with modifications within the spirit and scope of the appended claims.

What is claimed is:

1. A stator of a magneto generator comprising:
a stator core that is arranged at an inner side of a plurality of permanent magnets fixedly secured to an inner peripheral wall surface of a bowl-shaped flywheel, and has a plurality of teeth each having a straight portion that extends in a radially outer direction and a flange portion that protrudes in a circumferential direction from a tip end of said straight portion; and
a magneto coil that has a conductor wound around each of said teeth for generating electric power by means of an alternating field from said permanent magnets;
wherein said stator core includes a laminated iron core composed of a plurality of intermediate plates laminated one over another, and end plates that are arranged in intimate contact with opposite side surfaces of said laminated iron core;
said intermediate plates and said end plates are formed of the same plate materials each having a flange segment that is a component element of said flange portion; and
at least one of said end plates arranged on at least one of said side surfaces has a bent portion that is formed by bending said flange segment and serves to prevent said magneto coils from collapsing in the radially outer direction.

2. The stator of a magneto generator as set forth in claim 1, wherein a plurality of end plates are arranged on at least one of said side surfaces in a superposed manner.

3. The stator of a magneto generator as set forth in claim 1, wherein said bent portion is formed by bending said flange segment so as to upstand in a radially inner direction.

4. The stator of a magneto generator as set forth in claim 1, wherein said bent portion is formed by bending opposite sides of said flange segment so as to upstand in a circumferential direction.

5. The stator of a magneto generator as set forth in claim 1, wherein said bent portion is formed by bending said flange segment so as to upstand in a radially inner direction, and by bending opposite sides of said flange segment so as to upstand in a circumferential direction.
